(19) United States
(12) Patent Application Publication
(10) Pub. No.: US 2012/0274550 A1
(43) Pub. Date: Nov. 1, 2012

(54) GESTURE MAPPING FOR DISPLAY DEVICE

(76) Inventors: Robert Campbell, Cupertino, CA (US); Bradley Suggs, Sunnyvale, CA (US); John McCarthy, Pleasanton, CA (US)

(21) Appl. No.: 13/386,121

(22) PCT Filed: Mar. 24, 2010
(86) PCT No.: PCT/US10/28531

§ 371 Date: Jan. 20, 2012

(51) Int. Cl. G06F 3/01

(52) U.S. Cl. 345/156

(57) ABSTRACT

Embodiments of the present invention disclose a gesture mapping method for a computer system including a display and a database coupled to a processor. According to one embodiment, the method includes storing a plurality of two-dimensional gestures for operating the computer system, and detecting the presence of an object within a field of view of at least two three-dimensional optical sensors. Positional information is associated with movement of the object, and this information is mapped to one of the plurality of gestures stored in the database. Furthermore, the processor is configured to determine a control operation for the mapped gesture based on the positional information and a location of the object with respect to the display.

### BACKGROUND

Providing efficient and intuitive interaction between a computer system and users thereof is essential for delivering an engaging and enjoyable user-experience. Today, most computer systems include a keyboard for allowing a user to manually input information into the computer system, and a mouse for selecting or highlighting items shown on an associated display unit. As computer systems have grown in popularity, however, alternate input and interaction systems have been developed. For example, touch-based, or touchscreen, computer systems allow a user to physically touch the display unit and have that touch registered as an input at the particular touch location, thereby enabling a user to interact physically with objects shown on the display.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a simplified block diagram of the gesture mapping system according to an embodiment of the present invention.

FIG. 2A is a three-dimensional perspective view of an all-in-one computer having multiple optical sensors, while FIG. 2B is a top down view of a display device and optical sensor including the field of view thereof according to an embodiment of the present invention.

FIG. 3 depicts an exemplary three-dimensional optical sensor 315 according to an embodiment of the invention.

FIG. 4 illustrates a computer system and hand movement interaction according to an embodiment of the present invention.

FIGS. 5A and 5B illustrate exemplary hand movements for the gesture mapping system according to an embodiment of the present invention.

FIGS. 6A-6C illustrate various three-dimensional gestures and exemplary two-dimensional gestures that can be mapped thereto in accordance with an embodiment of the present invention.

FIG. 7 illustrates the steps for mapping hand movements and gesture actions according to an embodiment of the present invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” and “e.g.” are used in an open-ended fashion, and thus should be interpreted to mean “including, but not limited to . . . ”. The term “couple” or “couples” is intended to mean either an indirect or direct connection. Thus, if a first component couples to a second component, that connection may be through a direct electrical connection, or through an indirect electrical connection via other components and connections, such as an optical electrical connection or wireless electrical connection. Furthermore, the term “system” refers to a collection of two or more hardware and/or software components, and may be used to refer to an electronic device or devices, or a sub-system thereof.

### DETAILED DESCRIPTION OF THE INVENTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In addition to basic touchscreen interaction, some computer systems include functionality that allows a user to perform some !notion of a body part (e.g. hand, fingers) so as to create a gesture that is recognized and assigned a specific function by the system. These gestures may be mapped to user actions that would be taken with a mouse (e.g. drag and drop), or can be specific to custom software. However, such systems have the disadvantage that the display screen must be physically touched by the user, or operator. Furthermore, many computer systems include control buttons (e.g. mute, volume control, fast forward, etc.) that require physical contact (i.e. depress) from a user. When used in public arenas (e.g. library), however, extensive touch contact can eventually lead to concerns regarding cleanliness and concerns regarding the wear and tear of the touch surface of the display screen.

There have been several solutions for combating cleanliness and surface damage issues in touch-based computing environments. One solution is to require users to wear gloves. This practice is common in medical settings, but not all types of touch-based sensors are capable of detecting a gloved finger or hand. Another solution is to cover the display screen with an anti-bacterial coating. However, these coatings need to be replaced after a certain period of time or use, much to the dismay and inconvenience of the owner or primary operator of the computer system. With regard to surface damage concerns, one solution includes overlaying a protective glass or plastic cover on the display screen. However, such an approach generally works best with specific types of touchscreen computing systems (e.g. optical), thereby limiting the usefulness and applicability of the protective covers.

Embodiments of the present invention disclose a system and method for mapping non-touch gestures (e.g. three-dimensional motion) with a defined set of two-dimensional motions so as to enable the navigation of a graphical user interface using natural hand movements from a user. According to one embodiment, a plurality of two-dimensional touch gestures are stored in a database. Three-dimensional optical sensors detect the presence of an object within a field of view, and a processor associates positional information with movement of an object within the field of view of the sensors. Furthermore, positional information of the object is then mapped with one of the plurality of gestures stored in the database. The processor determines a corresponding control or input operation for the gesture based on the positional information and a location of the object with respect to the display.

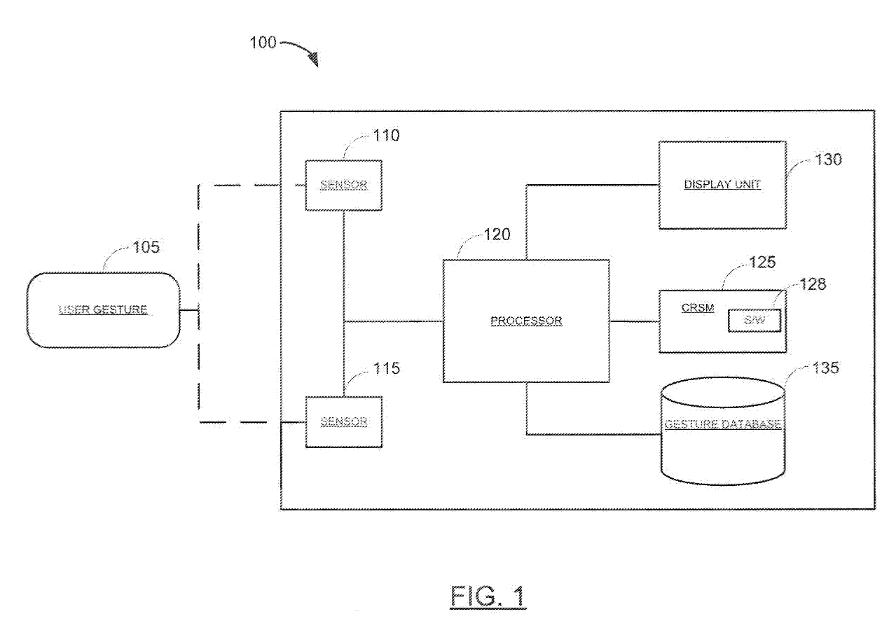

Referring now in more detail to the drawings in which like numerals identify corresponding parts throughout the views, FIG. 1 is a simplified block diagram of the gesture mapping system according to an embodiment of the present invention. As shown in this exemplary embodiment, the system 100 includes a processor 120 coupled to a display unit 130, a gesture database 135, a computer-readable storage medium 125, and three-dimensional sensors 110 and 115. In one embodiment, processor 120 represents a central processing unit configured to execute program instructions. Display unit 130 represents an electronic visual display or touch-sensitive display such as a desktop flat panel monitor configured to display images and a graphical user interface for enabling interaction between the user and the computer system. Storage medium 125 represents volatile storage (e.g. random access memory), non-volatile store (e.g. hard disk drive, read-only memory, compact disc read only memory, flash storage, etc.), or combinations thereof. Furthermore, storage medium 125 includes software 128 that is executable by processor 120 and, that when executed, causes the processor 120 to perform some or all of the functionality described herein.

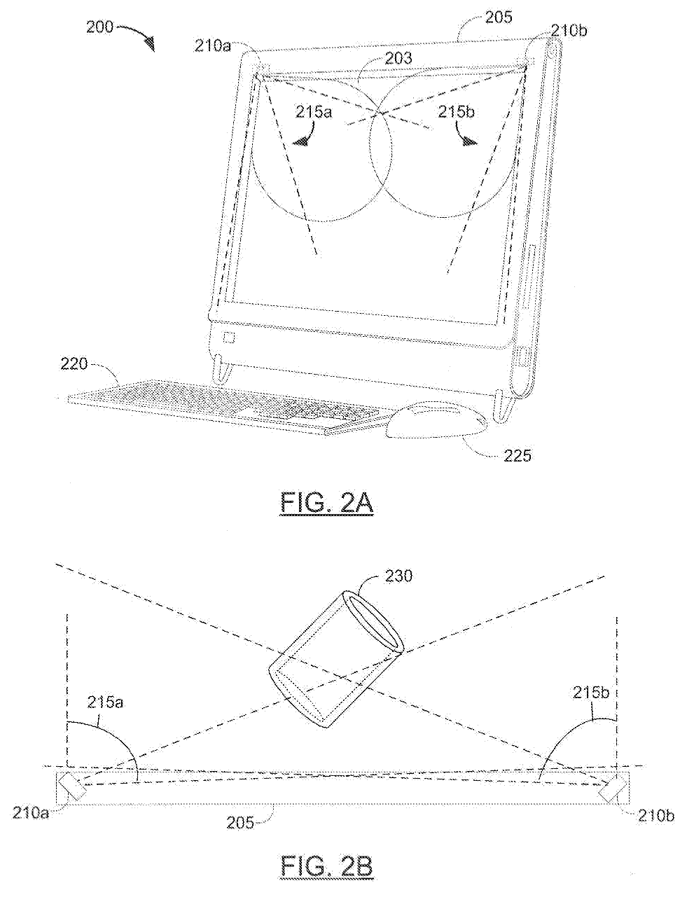

FIG. 2A is a three-dimensional perspective view of an all-in-one computer having multiple optical sensors, while FIG. 2B is a top down view of a display device and optical sensors including the field of view thereof according to an embodiment of the present invention. As shown in FIG. 2A, the system 200 includes a housing 205 for enclosing a display device 203 and three-dimensional optical sensors 210a and 210b. The system also includes input devices such as a keyboard 220 and a mouse 225. Optical sensors 210a and 210b are configured to report a three-dimensional depth map to the processor. The depth map changes over time as the object 230 moves in respective field of view 215a of optical sensor 210a and field of view 215b of optical sensor 210b. In one embodiment, optical sensors 210a and 210b are positioned at top most corners of the display such that each field of view 215a and 215b includes the areas above and surrounding the display device 203. As such, an object such as a user's hand for example, may be detected and any associated motions around the perimeter and in front of the computer system 200 can be accurately interpreted.

Furthermore, the inclusion of two optical sensors allows distances and depth to be measured from each sensor (i.e. different perspectives), thus creating a stereoscopic view of the three-dimensional scene and allowing the system to accurately detect the presence and movement of objects or hand poses. For example, and as shown in the embodiment of FIG. 2B, the perspective created by the field of view 215b of optical sensor 210b would enable detection of depth, height, width, and orientation of object 230 at its current inclined position with respect to a first reference plane. Furthermore, the processor may analyze and store this data as positional information to be associated with detected object 230. Due to the angled position of the object 230, however, optical sensor 210b may not capture the hollowness of object 230 and therefore recognize object 230 as only a cylinder in the present embodiment. Nevertheless, the perspective afforded by the field of view 215a will enable optical sensor 210a to detect the depth and cavity 233 within object 230 using a second reference plane, thereby recognizing object 230 as a tubular-shaped object rather than a solid cylinder. Therefore, the views and perspectives of both optical sensors 210a and 210b work together to recreate a precise three-dimensional map of the detected object 230.

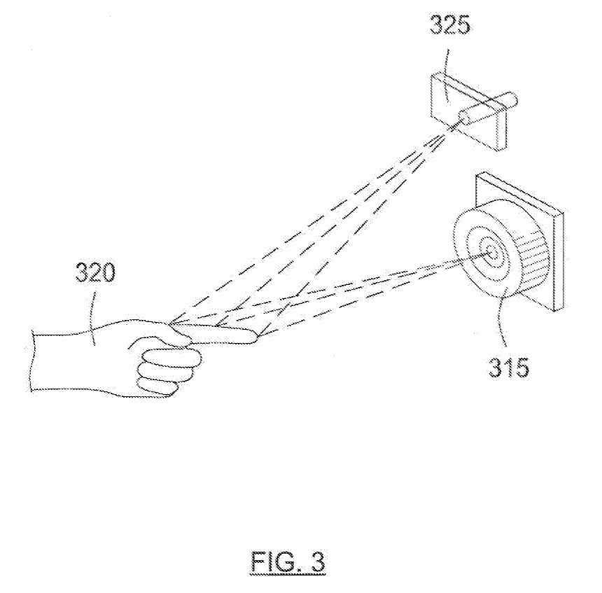

FIG. 3 depicts an exemplary three-dimensional optical sensor 315 according to an embodiment of the invention. The three-dimensional optical sensor 315 can receive light from a source 325 reflected from an object 320. The light source 325 may be an infrared light or a laser light source for example, that emits light and is invisible to the user. The light source 325 can be in any position relative to the three-dimensional optical sensor 315 that allows the light, to reflect off the object 320 and be captured by the three-dimensional optical sensor 315. The infrared light can reflect from an object 320 that may be the user's hand in one embodiment, and is captured by the three-dimensional optical sensor 315. An object in a three-dimensional image is mapped to different planes giving a Z-order, order in distance, for each object. The Z-order can enable a computer program to distinguish the foreground objects from the background and can enable a computer program to determine the distance the object is from the display.

Two-dimensional sensors that use a triangulation based methods may involve intensive image processing to approximate the depth of objects. Generally, two-dimensional image processing uses data from a sensor and processes the data to generate data that is normally not available from a two-dimensional sensor. Color and intensive image processing may not be used for a three-dimensional sensor because the data from the three-dimensional sensor includes depth data. For example, the image processing for a time of flight using a three-dimensional optical sensor may involve a simple table-lookup to map the sensor reading to the distance of an object from the display. The time of flight sensor determines the depth from the sensor of an object from the time that it takes for light to travel from a known source, reflect from an object and return to the three-dimensional optical sensor.

In an alternative embodiment, the light source can emit structured light that is the projection of a light pattern such as a plane, grid, or more complex shape at a known angle onto an object. The way that the light pattern deforms when striking surfaces allows vision systems to calculate the depth and surface information of the objects in the scene. Integral Imaging is a technique which provides a full parallax stereoscopic view. To record the information of an object, a micro lens array in conjunction with a high resolution optical sensor is used. Due to a different position of each micro lens with respect to the imaged object, multiple perspectives of the object can be imaged onto an optical sensor. The recorded image that contains elemental images from each micro lens can be electronically transferred and then reconstructed in image processing. In some embodiments the integral imaging lenses can have different focal lengths and the objects depth is determined based on if the object is in focus, a focus sensor, or out of focus, a defocus sensor. However, embodiments of the present invention are not limited to any particular type of three-dimensional optical sensor.

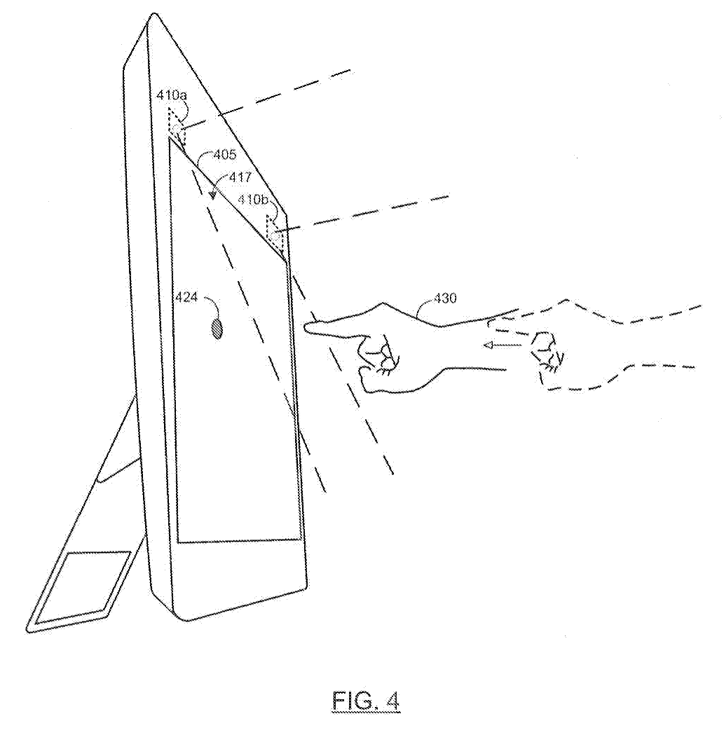

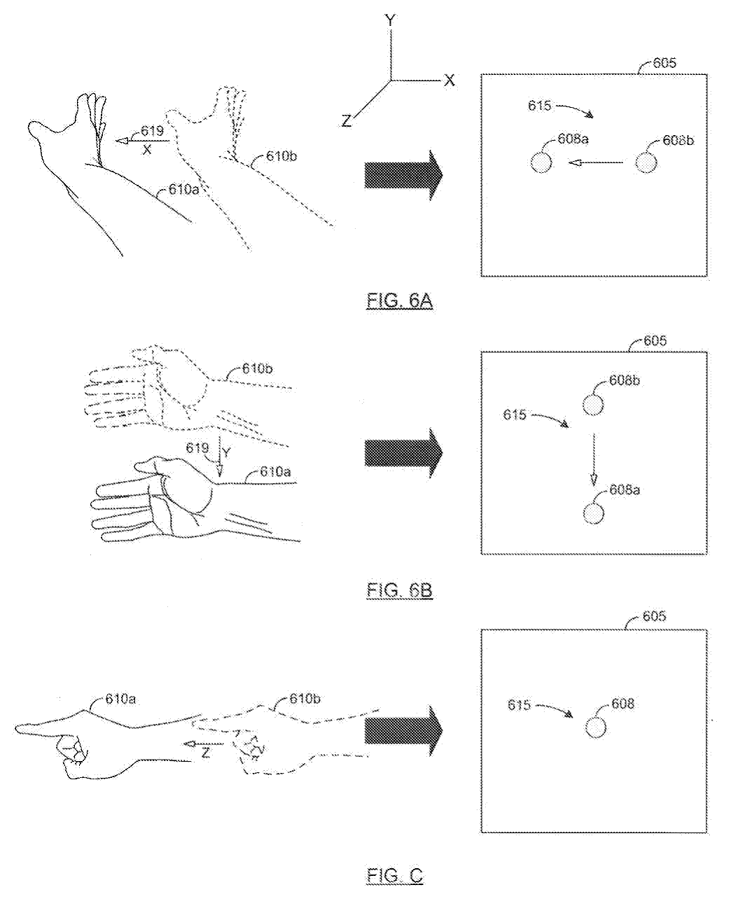

FIG. 4 illustrates a computer system and hand movement interaction according to an embodiment of the present invention. According to the present embodiment, an object 430 such as a user's hand, approaches the front surface 417 of display unit 405. When the object 430 is within the field of view and at a predetermined distance away from the front surface 417 of the display unit, the processor analyzes the movement 430 of the object and associates positional information therewith. In particular, and according to one embodiment, the positional information is continuously updated by the processor during the continuous moving sequence of object 430 within the field of view and includes the frequency of consecutive images, or frame rate, of the moving object 430 as captured by optical sensors. Based on the positional information, the processor is further configured to map a two-dimensional touch gesture with the movement of object 430, and also determine a control operation for the mapped gesture. In the present embodiment, the user's hand moves inward and perpendicular to the front surface 417 of the display unit 405. As shown here, a mouse click or selection operation indicated by touchpoint 424 is determined as the control operation for the mapped gesture of the present embodiment. Many different hand movements and gestures can be mapped together utilizing embodiments of the present invention as will be explained in more detail with reference to FIGS. 6A-6C.

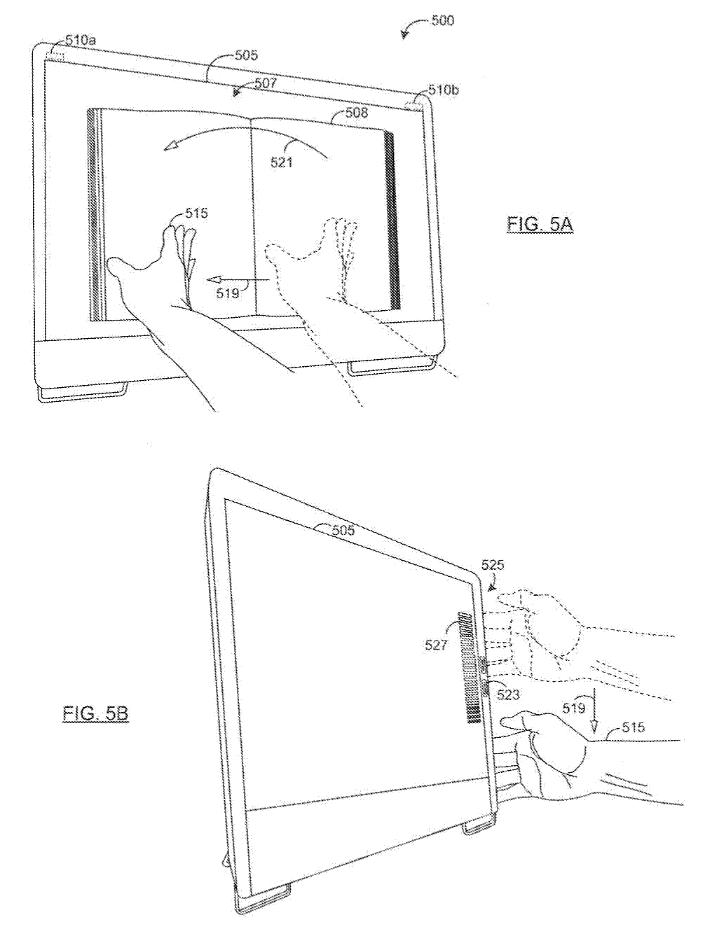

FIGS. 5A and 5B illustrate exemplary hand movements for the gesture mapping system according to an embodiment of the present invention. As shown in FIG. 5A, an object 515 such as a user's hand for example, moves horizontally across and parallel to the front surface 507 of display unit 505 as indicated by the directional arrow. Furthermore, and as in the embodiment described above, optical sensors 510a and 510b are configured to detect the movement of object 515, and the processor associates positional information therewith. In accordance with the associated positional information, the processor maps a two-dimensional touch gesture with the movement of object 515 and determines a control operation for the mapped gesture based on the positional information (e.g. horizontal, open handed movement) and the location of the object movement with respect to the display unit 505 (i.e. front area). As shown here, the display unit 505 displays an image of electronic reading material 508 such as e-book or e-magazine. In the present embodiment, the right to left horizontal movement of object 515 causes the processor to execute a control operation that turns the page of reading material 508 from right to left as indicated by directional arrow 521. Furthermore, numerous control operations may be assigned to a particular gesture, and execution of each operation may be based on the presently displayed image or graphical user interface. For example, the horizontal gesture referenced above may also be mapped to a control operation that closes a currently displayed document.

FIG. 5B illustrates another exemplary hand movement for the gesture mapping system according to an embodiment of the present invention. As shown here, computer system 500 includes a display unit 505 and control buttons 523 positioned along the outer perimeter of the display unit 505. Control buttons 523 may be volume control buttons for increasing or decreasing the audible volume of the computer system 500. An object 515 such as a user's hand for example, moves downward along an outer side area 525 of the display unit 505 as indicated by the directional arrow 519, and in close proximity to control buttons 503. As described above, movement of the object 515 is detected and the processor associates positional information therewith. In addition, the processor maps a two-dimensional touch gesture with the movement of object 515 and determines a control operation for the mapped gesture based on the positional information (e.g. downward, open-handed movement) and the location of the movement with respect to the display unit (i.e. outer-side area, close to volume buttons). According to this exemplary embodiment, the processor determines the control operation to be volume decrease operation and decreases the volume of the system as indicated by the shaded bars of volume meter 527. Still further, many other control buttons may be used for gesture control operation. For example, fast forward and rewind buttons for video playback may be mapped to a particular gesture. In one embodiment, individual keyboard strokes and mouse clicks may be mapped to non-contact typing or pointing gestures on a keyboard or touchpad.

FIGS. 6A-6C illustrate various three-dimensional gestures and exemplary two-dimensional gestures that can be mapped thereto in accordance with an embodiment of the present invention. As shown in these exemplary embodiments, three-dimensional object 610 is represented by a user's hand. Furthermore, touchpoints 608a and 608b correspond to two-dimensional touch locations and together represent a two-dimensional touch gesture 615 associated with a touchscreen display device 605.

In the embodiment of FIG. 6A, a right to left hand movement in the X-direction as indicated by directional arrow 619, is mapped to touch gesture 615. More specifically, the processor analyzes starting hand position 610b and continuously monitors and updates its change in position and time (i.e. positional information) to an ending position 610b. For example, the processor may detect the starting band position 610b at time A and monitor and update the change in positional information of the hand until a predetermined time B (e.g. 1 second) or ending position 610b. The processor may analyze the positional information as a right to left swipe gesture and accordingly maps the movement to a two-dimensional touch gesture 615, which includes starting touchpoint 608b moving horizontally toward ending touchpoint 608a.

FIG. 6B depicts a three-dimensional motion of a user's hand moving downward in the Y-direction as indicated by directional arrow 619. The processor analyzes the starting hand position 610b and continuously monitors and updates its change in position and time to an ending position 6I0b as in FIG. 6A. Here, the processor determines this movement as a downward slide gesture and accordingly maps the movement to two-dimensional touch gesture 615, which includes starting touchpoint 608b moving vertically and downward toward ending touchpoint 608b. Furthermore, FIG. 6C depicts a three-dimensional motion of a user's hand moving inward toward a display unit in the Z-direction as indicated by direction arrow 619. The processor analyzes the starting hand position 610b and continuously monitors and updates its change in position and time to an ending position 610b as described with respect to FIG. 6A. Here, the processor determines this movement as a selection or click gesture and accordingly maps the movement to a two-dimensional touch gesture 615, which includes single touchpoint 608.

Though FIGS. 6A-6C depict three examples of the gesture mapping system, embodiments of the invention are not limited thereto as many other types of three-dimensional motions and gestures may be mapped. For example, a three-dimensional motion that involves the user holding a thumb and forefinger apart and pinching them together could be mapped to two-dimensional pinch and drag gesture and control operation. In another example, a user may move their hands in a motion that represents grabbing an object on the screen and rotating the object in a clockwise or counterclockwise direction.

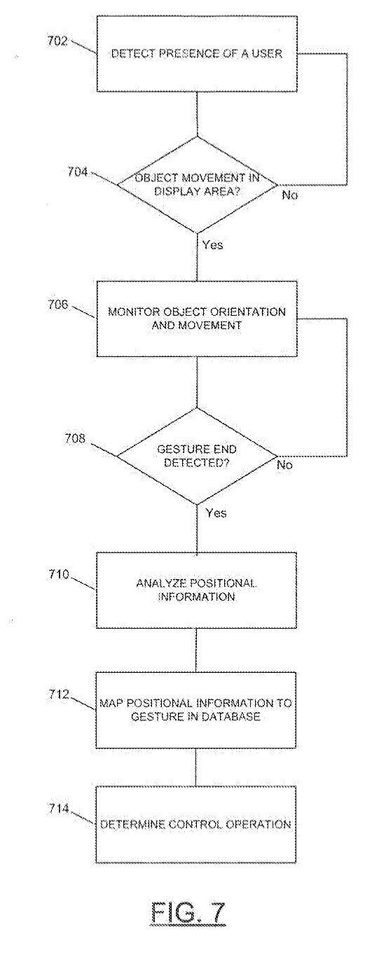

FIG. 7 illustrates a flow diagram of the steps for mapping hand movements and gesture actions according to an embodiment of the present invention. In step 702, the processor detects the presence of a user based on data received from at least one three-dimensional optical sensor. Initially, the received data includes depth information including the depth of the object from the optical sensor within its respective field of view. In step 704, the processor determines if the depth information includes movement of the object within a predetermined distance (e.g. within one meter), or display area of the computer system. If not, the processor continues to monitor the depth information until the object is within the display area. In step 706, the processor associates positional information with the object and continuously updates the positional information as the object moves over a predetermined time interval. In particular, movement of the object is continuously monitored and data updated until the end of the movement is detected by the processor based on the predetermined lapse of time or particular position of the object (e.g. hand goes from opened to closed position). In step 710, the processor analyzes the positional information and in step 712, maps the positional information associated with the three-dimensional object to a two-dimensional gesture stored in the database. Thereafter, in step 714, the processor determines a specific control operation for the movement based on the mapped gesture and associated positional information, and the location of the object with respect to the display.

Embodiments of the present invention provide a method and system for mapping a three-dimensional gesture with a stored two-dimensional touch gesture for operating a computer system. Many advantages are afforded by the gesture mapping method of embodiments of the present invention. For instance, a user interface that was designed for simple touch input method can be immediately converted for used with the three-dimensional depth sensors and three-dimensional gesture input from a user. Furthermore, natural user gestures can be mapped to user interface elements on the screen such as graphical icons for example, or off the screen such as physical buttons for example.

Furthermore, while the invention has been described with respect to exemplary embodiments, one skilled in the art will recognize that numerous modifications are possible. For example, although exemplary embodiments depict a notebook computer as the portable electronic device, the invention is not limited thereto. Furthermore, the system may be an all-in-one computer as the representative computer system, but may be implemented in a handheld system. For example, the gesture mapping system may be similarly incorporated in a laptop, a netbook, a tablet personal computer, a hand held unit such as a electronic reading device, or any other electronic device configured with an electronic touchscreen display.

Furthermore, the three-dimensional object may be any device, body part, or item capable of being recognized by the three-dimensional optical sensors of embodiments of the present embodiments. For example, a stylus, ball-point pen, or small paint brush may be used as a representative three-dimensional object by a user for simulating painting motions to be interpreted by a computer system running a painting application. That is, a plurality of three-dimensional gestures may be mapped to a plurality of two-dimensional gestures configured to control operation of a computer system.

In the foregoing description, numerous details are set forth to provide an understanding of the present invention. However, it will be understood by those skilled in the art that the present invention may be practiced without these details. Thus, although the invention has been described with respect to exemplary embodiments, it will be appreciated that the invention is intended to cover all modifications and equivalents within the scope of the following claims.

What is claimed is:

1. A method for interacting with a computer system including a display device and a database coupled to a processor, the method comprising:
storing, in the database, a plurality of two-dimensional gestures for operating the computer system;
detecting, via at least two three-dimensional optical sensors coupled to the processor, the presence of an object within a field of view of the sensors;
associating, via the processor, positional information with movement of the object within the field of view of the sensors;
mapping, via the processor, the positional information of the object with one of the plurality of gestures stored in the database;
determining, via the processor, a control operation based on the mapped gesture and a location of the object with respect to the display.

2. The method of claim 1, wherein at least one sensor is configured to obtain positional information of the object from a first perspective and at least one sensor is configured to obtain positional information of the object from a second perspective.

3. The method of claim 2, wherein the positional information includes the height, width, depth, and orientation of the object.

4. The method of claim 2, wherein associating positional information with movement of the object comprises:
analyzing a starting position of the object; and
continually updating the positional data associated with the object until an ending position of the object is determined.

5. The method of claim 1, wherein the object is a hand of a user and the plurality of gestures stored in the database are a set of different hand movements.

6. The method of claim 1, wherein the control operation is an executable instruction by the processor that performs a specific function on the computer system.

7. The method of claim 6, wherein when the object is within the field of view of and in front of the display device, movement of the object from a first position to a second position causes scrollable data shown on display device to scroll in a direction from the first position to the second position.

8. The method of claim 7, wherein movement of the object within close proximity to a physical button of the computer system, causes a control operation associated with the physical button to be executed by the processor.

9. A system comprising:
a display coupled to a processor;
a database coupled to the processor and configured to store a set of two-dimensional gestures for operating the system;
at least two three-dimensional optical sensors configured to detect movement of an object within a field of view of either optical sensor;
wherein upon detection of an object within the field of view of at least one sensor, the processor is configured to:
map movement of the object with at least one gesture in the set of gestures stored in the database, and
determine an executable control operation based on the mapped gesture and a location of the object with respect to the display.

10. The system of claim 9, wherein at least one sensor is configured to obtain positional information of the object from a first perspective and at least one sensor is configured to obtain positional information of the object from a second perspective.

11. The system of claim 10, wherein the positional information includes the height, width, depth, and orientation of the object.

12. The system of claim 10, wherein the processor is further configured to:
analyze a starting position of the object; and
continually update the positional data associated with the object until an ending position of the object is determined.

13. The system of claim 12, wherein the object is a hand of a user and the plurality of gestures stored in the database are a set of different hand movements.

14. A computer readable storage medium having stored executable instructions, that when executed by a processor, causes the processor to:
store a plurality of two-dimensional gestures in a database;
detect the presence of a user's hand within a field of view of at least two three-dimensional optical sensors;
associate positional information with movement of the hand within the field of view of the sensors;
map the positional information of the hand with one of the plurality of hand gestures stored in the database;
determine a control operation for the hand gesture based on the positional information and a location of the hand with respect to the display.

15. The computer readable storage medium of claim 14, wherein the executable instructions further cause the processor to:
analyze a starting position of the hand; and
continually update the positional data associated with the hand until an ending position of the hand is determined.
